(19) United States
(12) Patent Application Publication
(10) Pub. No.: US 2011/0291812 A1
(43) Pub. Date: Dec. 1, 2011

(54) SYSTEM FOR CREATING A CERTAIN ATMOSPHERE IN A ROOM

(75) Inventor: Stefan Marcus Verbrugh, Eindhoven (NL)

(73) Assignee: KONINKLIJKE PHILIPS ELECTRONICS, N.V., EINDHOVEN (NL)

(21) Appl. No.: 11/813,118

(22) PCT Filed: Jan. 11, 2006
(86) PCT No.: PCT/IB2006/050100

§ 371 Date: Jun. 29, 2007

(30) Foreign Application Priority Data
Jan. 12, 2005 (EP) 0510041.0

(51) Int. Cl. G06K 7/01

(52) U.S. Cl. 340/10.5

(57) ABSTRACT

A system for varying the atmosphere in a room, the system comprising at least one adjustable atmosphere-creating device (3, 4, 5, 6) and control means (8) for adjusting said device. Furthermore, the system comprises signal-receiving means (7) for receiving data being carried by a consumer product (1), wherein the control means can adjust said device in dependence upon the data received by the signal-receiving means. The consumer product can be provided with a passive radio frequency tag (2).

The invention relates to a system for varying the atmosphere in a room, the system comprising at least one adjustable atmosphere-creating device and control means for adjusting said device. Such an atmosphere-creating device may be one or more lamps for lighting the room, and/or a music-producing device such as a CD-player, and/or an air-conditioning device for establishing a certain temperature in the room, etc.

Adjustment of the atmosphere in a room may be desired in order to adapt it to the wishes of the person or persons being present in this room, and often such wishes depend on the activity that the persons are planning to do. For example, when coming home after a workday, it may be desired to switch on relaxing music and provide sufficient lighting in the living-room to read the newspaper. Or, in other circumstances, it may be desired to provide diffuse lighting and romantic music, for example, when the person or persons in the room like to drink a glass of wine before bed-time.

In order to automatically adapt the atmosphere in a room to the wishes of the persons in this room, atmosphere-creating devices can be controlled in dependence upon the time of day, and/or the weather, and/or other data that can be programmed in the control means, and/or circumstances that can be detected by the control means.

It is an object of the invention to provide a system for automatically varying the atmosphere in a room, wherein the atmosphere is adapted in dependence upon the activity that the person or persons in the room intend to do and/or wherein an atmosphere is created which is associated with a product that is used or consumed in this room.

In order to achieve this object, the system for varying the atmosphere in the room comprises signal-receiving means for receiving data being carried by a consumer product, wherein the control means can adjust said atmosphere-creating device in dependence upon the data received by the signal-receiving means. The consumer product may be provided with an information carrier. The data on the consumer product may be only an identification code with which the corresponding settings of the atmosphere-creating device or devices are programmed in the control means. However, said data preferably comprises information about the required adjustment (settings) of said device or devices.

The activity of a person or persons in a room is often associated with a certain consumer product to be used or consumed during said activity. It is therefore possible to predict the activity of a person or persons in a room after the presence of said consumer product has been detected, wherein predetermined data carried by the consumer product is detected by the signal-receiving means (or detector) of the system.

A consumer product provided with an information carrier is disclosed in U.S. 2002/0026325. This publication describes a food-managing system, in which the food is provided with an identification carrier that is automatically read when the food is stored in the refrigerator. After identification of the food, information about processing the food becomes available through the food-managing system.

The presence of the consumer product, and the information carried by it, can be detected in several ways. For example, if the consumer product is a container, such as a bottle containing a liquid, the container may be given a particular shape which can be recognized by means of a detector in a holder in which the container can be placed before it is opened. For example, the bottle may contain a liquid such as wine to be drunk in the living-room in which a certain atmosphere including diffuse lighting and soft romantic music is created. In another example, the bottle may contain a perfumed bath oil, in which certain data, carried by the bottle, is recognized by a detector, resulting in a predetermined lighting of the bathroom.

The consumer product may carry a bar code comprising the information, with a barcode reader being present in the room where the product is used or consumed. However, in one preferred embodiment, the consumer product, or its container, is provided with a data-emitting member, preferably a radio frequency (RF) tag, more preferably a passive radio frequency tag.

Radio frequency communication tags, or identification tags, come in two varieties: active and passive tags. An active radio frequency tag includes a battery or other power source and is activated by a signal from the signal-receiving means, i.e. the reading device. The activated radio frequency tag broadcasts its identification and/or other data, which is picked up by the reading device. An advantage of active radio frequency tags over passive radio frequency tags is that the inclusion of a power source allows the active radio frequency tag to transmit to the signal-receiving means without entering into an electromagnetic field to power the tag circuit. Active radio frequency tags are also generally able to transmit over a longer distance. The advantages of active radio frequency tags have led to their use in automatic toll-pay systems, or the like. However, an active radio frequency tag has certain disadvantage as compared to a passive radio frequency tag. For example, since the active radio frequency tag requires a battery or other power source, it is more expensive and heavier than a passive radio frequency tag. Additionally, the active radio frequency tag becomes useless when the battery or other power source is depleted.

Passive radio frequency tags have no power supply per se, but power is provided to the radio frequency tag circuitry by using an electromagnetic power receiver. The radio frequency tag-reading device, i.e. the signal-receiving means, sends power to the radio frequency tag's electromagnetic power receiver, thus powering up or tuning on the radio frequency tag's circuits. Subsequently, the passive radio frequency tag broadcasts a response signal comprising identification and/or other information, which is then read by the reading device. Since the passive radio frequency tag has no battery, it is less expensive and lighter. Passive radio frequency tags have been used for some time, notably in security access cards which users hold near the card reader to unlock a door, and in clothing stores as security tags attached to clothing items.

Data including any kind of information can be stored in the radio frequency tag, in order to identify the product to which it is attached and/or to have certain information available together with this product. This data is broadcast by the radio frequency tag when the tag is powered by the signal-receiving means (reader), whereby electromagnetic energy is received by the radio frequency tag, which energy is used for emitting radio frequency signals comprising the data to be transmitted from the radio frequency tag to the reader.

The radio frequency tag can be attached to the consumer product, or its container, by the manufacturer of the product. The manufacturer can determine the atmosphere in the room where the product is consumed or used by providing the radio frequency tag with appropriate information that can be received by the signal-receiving means in this room. It may be necessary that a person holds the product near the signal-receiving means for a moment, so that he can decide whether or not the predetermined atmosphere will be created.

In one preferred embodiment, said atmosphere-creating device comprises a lamp, whose intensity and/or color of its light are adjustable by said control means. The lighting of a room is often the main creator of the atmosphere in the room. Therefore, the atmosphere in a room can be easily influenced by changing the lighting, for example, from lighting by means of spotlights generating light beams towards a table or towards paintings on the wall of the room, to lighting by means of lamps generating soft diffuse light. Also the color and intensity of the light may determine the atmosphere in a room.

Said atmosphere-creating device preferably comprises a music player, whose volume and/or music genre are adjustable by said control means. Apart from lighting, also background music in a room may be responsible for a certain predetermined atmosphere in this room. In one preferred embodiment, said atmosphere-creating device comprises a heater/cooler device for adjusting the temperature in the room, which temperature and/or other conditions of the air are adjustable by said control means.

In one preferred embodiment, said control means are connected to the Internet and can search for information about a predetermined adjustment of the atmosphere-creating device in dependence upon an identification code carried by the consumer product. The manufacturer of the consumer product, or another company, can put the required information about the adjustment of the atmosphere-creating devices on an Internet site, which site can be visited automatically after a certain identification code of the consumer product is read by the reader and forwarded to the control device.

The invention also relates to a consumer product provided with a passive radio frequency tag containing information related to a predetermined atmosphere to be created when using or consuming the product.

The invention further relates to a method of varying the atmosphere in a room, wherein at least one adjustable atmosphere-creating device is adjusted by control means, signal-receiving means receive data being carried by a consumer product, and the control means adjust said device in dependence upon the data received by the signal-receiving means.

By making use of the described system and method, it is possible for a company not only to sell a product to the public, but to supply, together with the product, a predetermined atmosphere in which the product can be used or consumed. The system fits in a smart environment, in which a lot of people like to live.

These and other aspects of the invention are apparent from and will be elucidated with reference to the embodiments described hereinafter.

In the drawings,

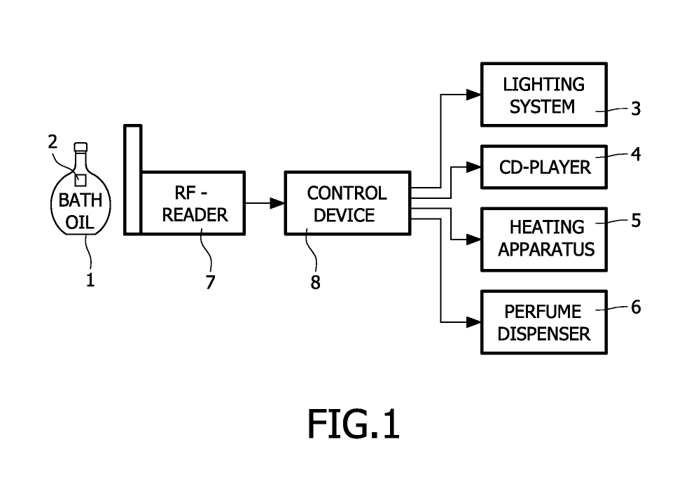

FIG. 1 is a schematic representation of a system for varying the atmosphere in a room depending on information carried by a consumer product;

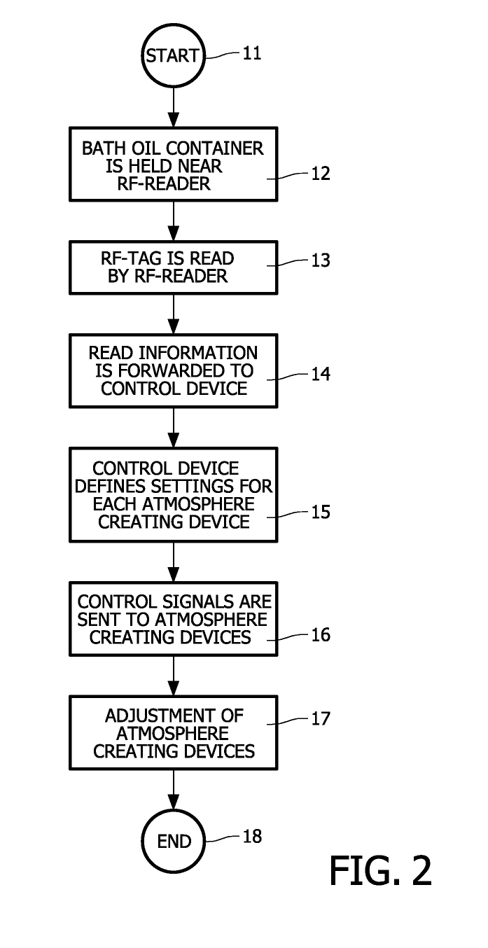

FIG. 2 is a flowchart of the process of adjusting the atmosphere depending on information carried by a consumer product.

FIG. 1 shows diagrammatically the system with which the atmosphere in a bathroom is varied in dependence upon the kind of bath oil used during bathing. The container 1 (bottle) with the chosen bath oil is provided with a passive radio frequency tag 2 in which certain information is stored, which information includes settings of a number of atmosphere-creating devices 3, 4, 5, 6. A radio frequency reader 7 is present in the bathroom, which device generates an electromagnetic field that powers the passive radio frequency tag 2 when this tag 2 is held close to the radio frequency reader 7 as is shown in FIG. 1. Then the radio frequency tag 2 broadcasts its information to the reader 7, which information is forwarded to the control device 8. The control device 8 is connected with four atmosphere-creating devices: the lighting system 3 in the bathroom; a music-producing apparatus 4, in this case a CD-player; a heating apparatus 5 for keeping the temperature in the bathroom at a desired value; and a perfume dispenser 6 for spreading a certain perfumed odour.

The lighting system 3 can contribute to creating a desired atmosphere, wherein the control device 8 adjusts the color and intensity of the light and switches certain lamps on or off so as to vary between direct light and diffuse light, etc. The CD-player 4 is provided with a cassette containing a number of CDs with different music genres, such as romantic music, relaxing music, inciting music, etc. The control device 8 can select the CD to be played. The heating apparatus 5 can generate heat radiation and can produce heated or cooled air. A certain combination of both heating methods, radiation and convection as defined by the control device 8, has its effect on the atmosphere in the bathroom. The perfume dispenser 6 can spread different kinds of perfumed odours, to be selected by the control device 8.

With reference to FIG. 1, FIG. 2 is a flowchart of the process of reading the radio frequency tag 2 on the bath oil container 1 and using its contents to create a predetermined atmosphere in the bathroom, according to the described embodiment of the invention. The process starts (process step 11) when the person who wants to take a bath holds (process step 12) the container 1 containing the bath oil that he wants to use during bathing near the radio frequency reader 7. The information in the radio frequency tag is read (process step 13) by the reader 7 and is forwarded (process step 14) to the control device 8. Then the control device 8 defines settings (process step 15) for the different atmosphere-creating devices 3, 4, 5, 6, which settings are prescribed in the information received from the reader 7. The appropriate control signals are sent (process step 16) to each atmosphere-creating device 3, 4, 5, 6, and each atmosphere-creating device 3, 4, 5, 6 is adjusted (process step 17) in accordance with the control signal sent to it. The process is terminated (process step 18), and the person can take his bath in an atmosphere predetermined by the bath oil manufacturer.

It will be apparent to those skilled in the art that various modifications and variations of the system and method of the present invention are possible without departing from the spirit and scope of the invention.

1. A system for varying the atmosphere in a room, the system comprising at least one adjustable atmosphere-creating device and control means for adjusting said device, characterized by signal-receiving means for receiving data being carried by a consumer product, wherein the control means can adjust said device in dependence upon the data received by the signal-receiving means.

2. A system as claimed in claim 1, characterized in that said data carried by the consumer product comprises information about a predetermined adjustment of the atmosphere-creating device.

3. A system as claimed in claim 1, characterized in that the consumer product is provided with a data-emitting member.

4. A system as claimed in claim 3, characterized in that said data-emitting member is a radio frequency (RF) tag.

5. A system as claimed in claim 1, characterized in that said atmosphere-creating device comprises a lamp, whose intensity and/or color of its light are adjustable by said control means.

6. A system as claimed in claim 1, characterized in that said atmosphere-creating device comprises a music player, whose volume and/or music genre are adjustable by said control means.

7. A system as claimed in claim 1, characterized in that said atmosphere-creating device comprises a heater/cooler device for adjusting the temperature in the room, which temperature and/or other conditions of the air are adjustable by said control means.

8. A system as claimed in claim 1, characterized in that said control means are connected to the Internet and can search for information about a predetermined adjustment of the atmosphere-creating device in dependence upon an identification code carried by the consumer product.

9. A consumer product, characterized in that the product is provided with a passive radio frequency tag containing information related to a predetermined atmosphere to be created when using or consuming the product.

10. A method of varying the atmosphere in a room, wherein at least one adjustable atmosphere-creating device is adjusted by control means, characterized in that signal-receiving means receive data being carried by a consumer product, and the control means adjust said device in dependence upon the data received by the signal-receiving means.
